(19) United States
(12) Patent Application Publication
(10) Pub. No.: US 2008/0113080 A1
(43) Pub. Date: May 15, 2008

(54) SHRIMP-BASED FOOD PRODUCTS AND METHODS OF MAKING SAME

(76) Inventor: John Hinnant Phifer, St. Helena Island, SC (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/871,506

(22) Filed: Oct. 12, 2007

Related U.S. Application Data
(60) Provisional application No. 60/829,161, filed on Oct. 12, 2006.

(51) Int. Cl. A23L 1/325

(52) U.S. Cl. 426/643

(57) ABSTRACT

A shrimp-based food product is provided that can be made in the form of a frankfurter or in the form of a food dip.

### TECHNICAL FIELD OF THE INVENTION

The invention relates to food products, and more particularly, the invention relates to a frankfurter food product that is made of ingredients other than those typically used to make frankfurters.

### BACKGROUND OF THE INVENTION

Frankfurters are sausage-shaped food products that are typically made of beef and/or pork. The term “frankfurter” is often used to describe the food product, which originated in Frankfurt, Germany. When placed in a sliced bun, a frankfurter is often referred to as a hot dog. Various types of condiments are often used as toppings on frankfurters and hot dogs to vary their flavors. Frankfurters are often sold in cooked or uncooked form, but hot dogs are typically sold in cooked form. The flavor of a frankfurter usually resembles bologna, but the flavor of spicier varieties resembles cooked salami. Frankfurters are sometimes served as finger foods that are smaller than hot dogs and typically referred to as franks.

The enjoyable taste and flavor of frankfurters and the ease with which they can be prepared and served has made these food products extremely popular for all types of events, including sporting events, picnics, family retreats, camping trips, and simply everyday life. While the typical beef or pork frankfurter will undoubtedly continue to remain very popular over time, it would be desirable to provide a frankfurter having a taste and flavor that is altogether different from that of a beef or pork frankfurter, but equally or even more enjoyable to eat, while maintaining the ease with which typical frankfurters can be prepared and served. The invention addresses such a need.

### SUMMARY OF THE INVENTION

The invention provides shrimp-based food products and methods of making the shrimp-based food products. The method comprises caramelizing seasoning ingredient, cooking a selected quantity of uncooked rice in broth, boiling a selected quantity of unpeeled shrimp in boiling water until the shrimp are deemed suitably cooked, removing the cooked shrimp from the boiling water, and mixing the cooked shrimp with the caramelized ingredients to obtain a shrimp-based food product. The shrimp-based food product may be a frankfurter or a dip.

These and other features and advantages of the invention will become apparent from the following description, drawings and claims.

### BRIEF DESCRIPTION OF THE DRAWINGS

FIG. 1 illustrates a flowchart that represents the method in accordance with an illustrative embodiment for making the dip food product.

FIG. 2 illustrates a flowchart that represents the method for making the Shrimp Dogs in accordance with an illustrative embodiment.

### DESCRIPTION OF ILLUSTRATIVE EMBODIMENTS OF THE INVENTION

The invention is a shrimp-based food product that is made of one or more ingredients, the primary one of which is shrimp. Because the food product of the invention can be served alone or on a sliced bun in the way that traditional hot dogs are served, the food product of the invention is referred to herein as a “Shrimp Dog”. In recent months, the Shrimp Dog of the invention has been served at various events in the coastal region of the southern parts of South Carolina and Georgia and has become extremely popular. In this part of the United States, which is commonly referred to as the low country due to its elevation being at approximately sea level, seafood is very popular, and boiled and fried shrimp are two of the most popular types of seafood consumed in this region. Although shrimp are prepared and served in a variety of ways in this region, they are normally prepared and served in traditional ways that have been practiced for hundreds of years.

In accordance with the invention, an experiment was conducted during which a quantity of fresh shrimp were peeled and de-veined, cooked by boiling them in boiling water, mixed with other ingredients to add seasoning and flavor, and processed into the frankfurter-type food products referred to herein as Shrimp Dogs. The Shrimp Dogs were then eaten. The experiment was successful in that the Shrimp Dogs had a very enjoyable taste and texture, as well as a high nutritional content. Subsequently, more Shrimp Dogs were prepared and served in various ways, and again proved to be very successful and very popular in the local low country community. Also, the mixture of ingredients that were used to make the shrimp dogs was eaten as a dipping sauce, which also proved to be very successful.

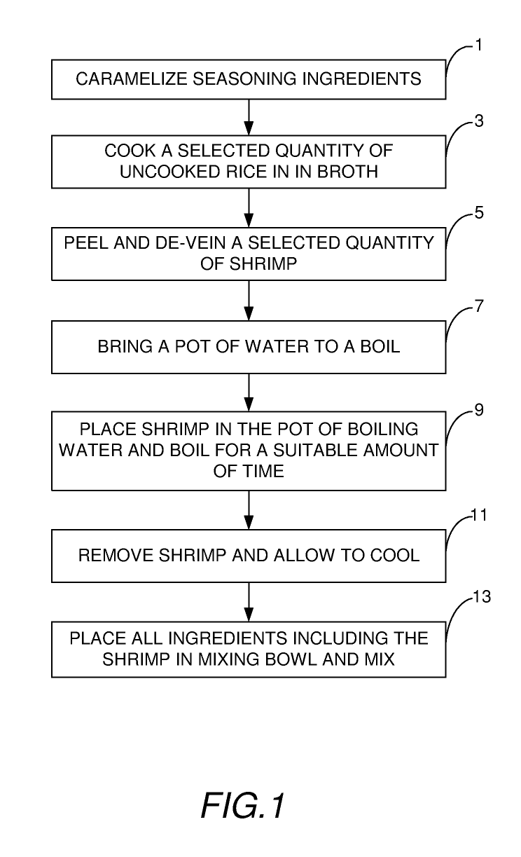

FIG. 1 illustrates a flowchart that represents the method in accordance with an illustrative embodiment for making the dip food product. The order in which the blocks are presented is not necessarily the order in which the tasks are performed, i.e., the sequence can be varied and some tasks may be performed simultaneously. Also, some of the steps are optional and/or can be varied as desired. The following ingredients are caramelized in a cooking pot or pan on a stove at medium heat, preferably in olive oil:
add approximately two cups of chopped spring onion;
add approximately ½ teaspoon (level) of cayenne pepper;
add some garlic pepper, typically 10 to 15 rotations of the grinder device;
add a moderate amount of Old Bay® Seasoning; and
   when the mixture has attained the desired consistency, the heat down on the stove is lowered and approximately two tablespoons of crushed garlic are added to the mixture; This process is represented by block 1 in FIG. 1.

Before, after or during the caramelizing process, approximately ½ cup of uncooked rice, preferably white rice, is cooked in chicken broth with a pinch of salt, as indicated by block 3 in FIG. 1.

Before, during or after the process represented by blocks 1 and 3 are performed, a desired quantity of shrimp to be used are peeled to remove the shells and legs and are de-veined, as indicated by block 5.

Before, during or after the process represented by blocks 1, 3 and 5 are performed, water that preferably is seasoned (e.g., with Old Bay® Seasoning) is brought to a boil in a cooking pot, as indicated by block 7. After the water has been brought to a boil, the peeled and de-veined shrimp (e.g., five pounds) are dropped into the boiling seasoned water and boiled for a suitable amount of time depending on the quantity of shrimp being boiled, as indicated by block 9. For example, if five pounds of shrimp are used, approximately one minute of boiling should be sufficient. It is important to avoid leaving the shrimp in the boiling water for too long so that they are not overcooked. The cooked shrimp are then removed from the pot and set aside to cool, as indicated by block 11.

After the tasks represented by blocks 1-11 have been performed, all of the above ingredients including the shrimp are placed in a mixing bowl and mixed together using a spoon or other mixing item, as indicated by block 13. After the ingredients have been suitably mixed, the mixture can be used as a dip that is eaten on crackers, bread or chips, for example. Prior to eating the dip, the dip may be further mixed together with a dipping sauce to provide additional flavor. The dipping sauce may comprise, for example, ranch dressing, Dijon mustard, a teaspoon of Tabasco sauce, and a teaspoon of Old Bay® Seasoning. If five pounds of shrimp are used, then preferably sixteen ounces of ranch dressing and ten ounces of Dijon mustard are used to make the dipping sauce that is mixed in with the mixture. In addition, prior to eating the dip, the dip may be further processed to make it more granular.

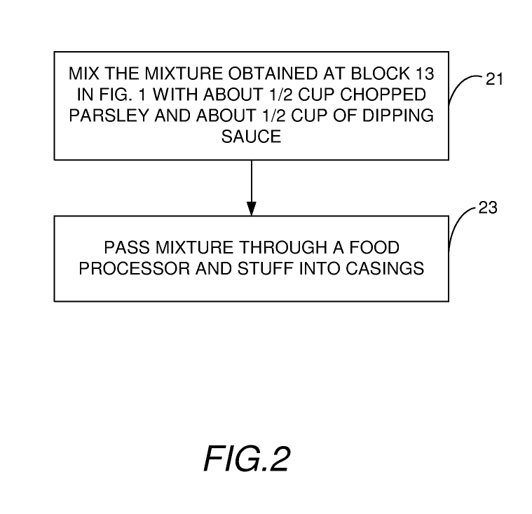

The mixture obtained at block 13 may be further processed to make the Shrimp Dogs of the invention, as will now be described with reference to FIG. 2. FIG. 2 illustrates a flowchart that represents the method for making the Shrimp Dogs in accordance with an illustrative embodiment. The mixture produced at block 13 shown in FIG. 1 preferably is mixed with approximately ½ cup of chopped parsley and approximately ½ cup of the dipping sauce described above, as indicated by block 21 in FIG. 2. This mixture is then gently passed through a food processor so as not to grind the shrimp too much and stuff into natural casings, as indicated by block 23. If the Shrimp Dog is to have approximately the same size as that of a typical beef or pork frankfurter, then sheep casings preferably are used. If the Shrimp Dog is to have approximately the same size as a bratwurst, then hog casings preferably are used.

The preferred method for cooking the Shrimp Dogs is to use an iron skillet on a gas grill or stove top in olive oil or vegetable oil, slowly on low heat while occasionally rolling the Shrimp Dog until the casings are slightly browned. The Shrimp Dogs may be served in any desired manner, such as, for example, on flat bread, pita wrap, Texas toast or a sliced bun, such as a hot dog bun.

It should be noted that the invention has been described with reference to preferred and illustrative embodiments and that the invention is not limited to these embodiments. For example, the ingredients described above can be varied in virtually an infinite number of ways to provide the dip or Shrimp Dog with a desired taste, flavor and texture. Also, while natural casings have been described above as being used in making the Shrimp Dogs, other methods and materials may be suitable for encasing or holding the Shrimp Dog material together. The invention is not limited with respect to the manner in which the dip and Shrimp Dog may be served. Those skilled in the art will understand that these and other modifications may be made without deviating from the scope of the invention.

1. A method for making a shrimp-based food product comprising:
caramelizing seasoning ingredients;
cooking a selected quantity of uncooked rice in broth;
boiling a selected quantity of unpeeled shrimp in boiling water until the shrimp are deemed suitably cooked;
removing the cooked shrimp from the boiling water; and
mixing the cooked shrimp with the caramelized ingredients to obtain a shrimp-based food product.

2. The method of claim 1, wherein the seasoning ingredients include at least one of chopped onion, cayenne pepper, garlic pepper, Old Bay® Seasoning, and crushed garlic.

3. The method of claim 2, wherein the rice is white rice and wherein the broth is chicken broth.

4. The method of claim 3, further comprising:
mixing the shrimp-based food product with a dipping sauce, the dipping sauce including at least one of ranch dressing, Dijon mustard, Tabasco sauce, and Old Bay® Seasoning.

5. The method of claim 1, further comprising:
passing the shrimp-based food product through a food processing device to obtain a processed food product.

6. The method of claim 5, further comprising:
stuffing the processed food product into a casing material, the encased food product generally having the shape of a frankfurter or sausage.

7. The method of claim 6, further comprising:
prior to passing the shrimp-based food product through a food processing device, mixing the shrimp-based food product with a dipping sauce, the dipping sauce including at least one of ranch dressing, Dijon mustard, Tabasco sauce, and Old Bay® Seasoning.

8. A shrimp-based food product made by the process of claim 1, wherein the shrimp-based food product is a dip.

9. A shrimp-based food product made by the process of claim 5, wherein the shrimp-based food product is a dip.

10. A shrimp-based food product made by the process of claim 5, wherein the shrimp-based food product is a Shrimp Dog.

11. A frankfurter-type food product comprising:
ingredients that have been processed to a selected consistency, the processed ingredients including cooked shrimp.

12. The food product of claim 11, wherein the processed ingredients further comprise:
caramelized seasoning ingredients; and
a selected quantity of rice that has been cooked in broth;

13. The food product of claim 12, wherein the shrimp have been cooked by boiling a selected quantity of unpeeled shrimp in boiling water until the shrimp are deemed suitably cooked.

14. The food product of claim 12, wherein the seasoning ingredients include at least one of chopped onion, cayenne pepper, garlic pepper, Old Bay® Seasoning, and crushed garlic.

15. The food product of claim 12, wherein the rice is white rice and wherein the broth is chicken broth.

16. The food product of claim 15, wherein the processed ingredients further include a dipping sauce, the dipping sauce including at least one of ranch dressing, Dijon mustard, Tabasco sauce, and Old Bay® Seasoning.

17. The food product of claim 11, further comprising:
a casing material that encases the processed food product, the encased food product generally having a shape of a frankfurter or sausage.
